(19) United States
(12) Patent Application Publication
(10) Pub. No.: US 2006/0196735 A1
(43) Pub. Date: Sep. 7, 2006

(54) Frameless elevator cab and methods

(75) Inventor: Dwayne Creston Long, Neenah, WI (US)

Correspondence Address: WILHELM LAW SERVICE, S.C., 100 W LAWRENCE ST, THIRD FLOOR, APPLETON, WI, 54911, US

(73) Assignee: Waupaca Elevator Company, Inc., Appleton, WI (US)

(21) Appl. No.: 11/074,915

(22) Filed: Mar. 7, 2005

(51) Int. Cl. B66B 11/02

(52) U.S. Cl. 187/401

(57) ABSTRACT

A frameless elevator cab includes a top wall, a bottom wall, and a plurality of sidewalls. Ones of the sidewalls are connected to and/or attached to each other with fastener members adapted and configured to provide multi-dimensional stability therebetween. In assembled frameless elevator cabs of the invention, the frameless elevator cab defines inner and outer cab perimeters and substantially no hardware which connects/attaches ones of the sidewalls to other ones of the sidewalls which are visible from inside the inner cab perimeter and/or outside the outer cab perimeter.

### BACKGROUND

This invention generally relates to apparatus for use in elevators, dumb waiters and other lifting/lowering devices. This invention further relates to elevator cab assemblies used in conjunction with lifting/lowering devices, e.g. elevator cabs, which ascend/lift, descend/lower, and/or otherwise carry passengers/cargo therein. This invention also relates to methods of assembling and/or otherwise constructing such elevator cabs.

Specifically, this invention relates to elevator cab assemblies which limit the amount of space required for installation and/or assembly, limit the amount of time required for installation and/or assembly of such cab assemblies, limits the amount of skill required for installation and/or assembly, and further relates to methods for such for installation and/or assembly of such cab for use in conjunction with, for example, an elevator system.

Conventional residential elevators typically have a lift apparatus comprising a drive unit such as a motor or other prime mover, and an associated winding unit which is driven by the prime mover. A gear box typically provides the interface between the prime mover and the winding unit. The gear box can be integral with the prime mover, integral with the winding unit, or may be a standalone separate and distinct unit. Elevators further include an elevator cab adapted and configured to transport passengers and/or cargo therein, wherein the cab is typically guided in generally vertically actuated travel by, for example, a plurality of guiderails.

The output of the lift apparatus is generally connected to a cable set, or other elongate connection apparatus which extends, downwardly to the car, downwardly to a frame which supports the car, or around a number of sheaves and thence over the sheaves and then downwardly to the car or downwardly to a frame which supports the car. The cables are thus connected to the car or car frame on one end and to the winding unit on the other end, with the sheaves guiding the cables between the car and the winding unit.

Numerous components and subassemblies of a typical elevator are housed in an elevator hoistway, which typically is a generally vertical shaft/chamber structure attached to, or contained within, a building. Some elevators, by contrast operate at a less-than-90 degree upright angle. By design, a typical elevator hoistway is a relatively small, cramped or otherwise restrictive space so as to limit the amount of the valuable floor space or square footage of the building in which the elevator hoistway is installed, which is occupied by the elevator hoistway.

In light of the relatively restrictive space of the elevator hoistway, installation and/or other assembly of elevator systems or components of elevator systems can be a relatively difficult and time consuming task. Accordingly, installation/assembly of elevator systems is typically performed by highly skilled and highly specialized craftspeople.

In addition, the installation/assembly of some of the individual components and subassemblies of an elevator system, namely elevator cabs, is relatively complex and/or time consuming, which is further complicated by the relatively restrictive areas available for use at, or near, the site of assembly/installation.

Typical elevator cabs include an e.g. steel “angle-iron” frame which holds a plurality of walls mounted thereto. The frame includes top and bottom rectangular “angle-iron” frame portions which house the top and bottom elevator cab walls about their respective perimeters. Also typically, vertically positioned “angle-irons” extend between the top and bottom frame portions and house the outer vertical seam corners between outer side wall surfaces of the elevator cab. In addition, typical elevator cabs further include at least one rigid strap which extends around the outer perimeter of the cab side walls, approximately three feet from the bottom wall of the cab.

The external frame structure of typical cabs requires that installers be positioned outside of the elevator cab when they, e.g. assemble/install the cab walls to the external frame. This can prove difficult and sometimes impossible when assembly/installation procedures are performed in relatively restrictive areas, such as in the elevator hoistway.

It would thus prove desirable and/or valuable to provide elevator cabs which an installer can install/assemble relatively quickly and easily and methods of installing/assembling such cabs. Correspondingly, it would prove useful and/or valuable to provide elevator cabs which can be installed in relatively restricted space.

### SUMMARY

This invention provides novel frameless elevator cabs, each of which includes a top wall, a bottom wall, and a plurality of sidewalls. Ones of the sidewalls are connected to and/or attached to other ones of the sidewalls with fastener members adapted and configured to provide multi-dimensional stability between the respective sidewalls. In assembled frameless elevator cabs of the invention, the frameless elevator cab defines inner and outer cab perimeters and substantially no hardware which connects/attaches ones of the sidewalls to other ones of the sidewalls which are visible from inside the inner cab perimeter and/or from outside the outer cab perimeter.

In a first family of embodiment, the invention comprehends a frameless elevator cab, comprising: (a) a plurality of sidewalls each having an upper portion and a lower portion and each having an outwardly facing surface and an inwardly facing surface, relative to a load-bearing cavity inside the frameless elevator cab, the outwardly facing surfaces collectively defining an outer cab perimeter and the inwardly facing surfaces collectively defining an inner cab perimeter; (b) a top wall communicating with the upper portions of the plurality of sidewalls; and (c) a bottom wall communicating with the lower portions of the plurality of sidewalls; the outwardly facing surfaces of the sidewalls collectively defining at least a substantial portion of the cab outer perimeter and the inwardly facing surfaces of the sidewalls collectively defining at least a substantial portion of the cab inner perimeter, the elevator cab outer perimeter, at the sidewalls, being substantially devoid of hardware extending therefrom and connecting ones of the sidewalls to each other and extending outwardly therefrom.

In some embodiments, the sidewalls comprising edge regions, at least some of the sidewalls comprising edge surfaces at the edge regions, the frameless elevator cab further comprising a first fastener member mounted on a first one of the sidewalls, in the edge region of the first sidewall at one of the inner surface, the outer surface, or the edge surface, and connecting one of the first sidewalls to a second one of the sidewalls through a second fastener member mounted in the edge region of the second sidewall, the second fastener member being mounted at one of the inner surface, the outer surface, or the edge surface of the second sidewalls, the first and second fastener members being substantially disposed between the inwardly facing surfaces and the outwardly facing surfaces of the first and second sidewalls.

In some embodiments, the first fastener member comprising a shoulder and a head, and a neck which extends between the shoulder and the head, the second fastener member comprising a receiving plate adapted and configured to receive the neck of the first fastener member.

In some embodiments, wherein the first and second fastener members cooperate so as to generally provide dimensional stability along at least first and second directions of stability to the frameless cab at an assembled cab corner defined by the first and second sidewalls, the first direction of stability being generally parallel to the direction of projection of the first fastener member and the second direction of stability being generally perpendicular to the direction of projection of the first fastener member.

In some embodiments, the cab further comprising an elevator cab closure, the closure, in combination with the sidewalls, when closed, defining the inner perimeter of the frameless cab.

In a second family of embodiments, the invention comprehends a frameless elevator cab, comprising: (a) a top wall and a bottom wall; (b) a plurality of sidewalls each having an outer sidewall surface, an upper sidewall surface, and opposing upstanding edge regions, each of the sidewalls extending generally between the top wall and the bottom wall; the sidewalls collectively defining a plurality of corners of the frameless cab at respective ones of the edge regions, and a cargo cavity inside the frameless elevator cab; and (c) connecting hardware in the edge regions connecting the sidewalls to each other at the corners; the connecting hardware being substantially confined to facing portions of the respective edge regions of the sidewalls so joined, such that the connecting hardware is substantially non-visible as viewed from inside the cargo cavity.

In a third family of embodiments, the invention comprehends a frameless elevator cab, comprising: (a) a top wall and a bottom wall; (b) a plurality of sidewalls each having an inner sidewall surface, an outer sidewall surface, and opposing upstanding edge regions, and each of the sidewalls extending generally between the top wall and the bottom wall, the sidewalls collectively defining a plurality of corners of the frameless cab at respective ones of the edge regions, and a cargo cavity inside the frameless cab; and (c) connecting hardware in the edge regions connecting the sidewalls to each other at the corners, the connecting hardware being substantially confined to facing portions of the respective edge regions of the sidewalls so joined, such that the connecting hardware is substantially non-visible as viewed from outside the frameless cab.

In a fourth family of embodiments, the invention comprehends a frameless elevator cab comprising: (a) a top wall and a bottom wall; (b) a plurality of sidewalls extending generally between the top wall and the bottom wall and joined to each other so as to generally define the frameless cab, and a cargo cavity inside the frameless cab, each of the sidewalls having inner and outer sidewall surfaces and upstanding edge regions, including edge regions having edge surfaces which extend generally between the respective inner and outer surfaces; and (c) at least one fastener member extending outwardly from and/or inwardly into a respective one of the edge surfaces, and fastening first and second ones of the walls to each other; wherein the inner and outer sidewall surfaces of such assembled frameless cab generally define substantial portions of inner and outer cab perimeters, such inner and outer cab perimeters, at respective joinders of the sidewalls, being substantially devoid of hardware attaching ones of the top wall, bottom wall, and sidewalls to each other and extending inwardly from the sidewalls into the cargo cavity.

In a fifth family of embodiments, the invention comprehends a frameless cab elevator system kit, comprising: (a) a prime mover; (b) a pair of generally elongate guiderails; (c) a sling in driven communication with the prime mover and movable along the pair of generally elongate guiderails; and (d) a frameless cab attached to the sling, the frameless cab comprising (i) a top wall and a bottom wall, and (ii) a plurality of sidewalls each having an outer sidewall surface and each extending generally between the top wall and the bottom wall; and the outer sidewall surfaces defining a substantial portion of a cab outer perimeter, such cab outer perimeter, adjacent the sidewalls, being devoid of hardware, connecting ones of the sidewalls to each other and extending substantially outwardly from the sidewalls.

In a sixth family of embodiments the invention comprehends a method of assembling a frameless elevator cab which has top and bottom walls, and first, second, and third sidewalls, the method comprising: (a) connecting the first sidewall to a bottom wall so that the bottom wall is generally parallel to the ground and the first sidewall extends generally upwardly from the bottom wall; (b) aligning a second sidewall, which has a lower corner portion distal from the first sidewall and a lateral edge portion proximate the first sidewall, with the first sidewall, and interfacing the lower corner portion of the second sidewall with the bottom wall and subsequently interfacing the lateral edge portion of the second sidewall with the first sidewall and slidingly engaging the first and second sidewalls so as to realize a multi-dimensionally stable connection therebetween; (c) aligning a third sidewall which has a lower corner portion distal from the second sidewall and a lateral edge portion proximate the second sidewall, with the second sidewall, and interfacing the lower corner portion of the third sidewall with the bottom wall and subsequently interfacing the lateral edge portion of the third sidewall with the second sidewall and slidingly engaging the second and third sidewalls so as to realize a multi-dimensionally stable connection between the second and third sidewalls.

In some embodiments, the frameless elevator cab further comprises a gate pocket, the method further comprising: (d) generally perpendicularly aligning a gate pocket which has a lower corner portion distal from the first sidewall and a lateral edge portion proximate the first sidewall, with the first sidewall, and interfacing the lower corner portion of the gate pocket with the bottom wall and subsequently interfacing the lateral edge portion of the gate pocket with the first sidewall and slidingly engaging the first sidewall and the gate pocket so as to realize a multi-dimensionally stable connection therebetween.

In some embodiments, the method further comprising: (e) generally aligning the top wall with the first, second, and third sidewalls and the gate pocket so that the top wall generally superposes the bottom wall and applying pressure against the top wall in the direction of the bottom wall thereby interfacing the top wall with the first, second, and third sidewalls and the gate pocket.

In a seventh family of embodiments, the invention comprehends a frameless elevator cab assembly comprising: (a) a sling having a generally upright sling portion and a generally horizontal sling portion which is generally perpendicular to the generally upright portion; and (b) a frameless cab attached to at least one of the generally upright sling portion and the generally horizontal sling portion, the frameless cab comprising (i) a top wall and a bottom wall, and (ii) a plurality of sidewalls each having an outer sidewall surface and each extending generally between the top wall and the bottom wall; and the outer sidewall surfaces defining a substantial portion of a cab outer perimeter, such cab outer perimeter, adjacent the sidewalls, being devoid of hardware, connecting ones of the sidewalls to each other and extending substantially outwardly from the sidewalls.

### BRIEF DESCRIPTION OF THE DRAWINGS

FIG. 1A shows a perspective view of a first elevator system which includes a first embodiment of frameless-cab assemblies of the invention.

FIG. 1B shows a perspective view of a second embodiment elevator system which includes a second embodiment of frameless-cab assemblies of the invention.

FIG. 2 shows a partially exploded perspective view of the frameless cab assembly of FIG. 1B.

FIG. 3 shows an exploded view of the cab of FIG. 1B.

FIG. 4A shows a side elevation of a post fastener useful in the cab assembly suggested by FIG. 3.

FIG. 4B shows a perspective view of a fastener bracket useful in the cab assembly suggested by FIG. 3.

FIG. 5A shows an enlarged perspective view of a first embodiment of a post fastener and a fastener bracket illustrated in FIG. 3, taken at the portion of FIG. 3 indicated by the dashed-line box which is labeled 5A, 5B.

FIG. 5B shows an enlarged perspective view of a second embodiment of a post fastener and fastener bracket of FIG. 3, taken at the portion of FIG. 3 indicated by the dashed-line box which is labeled as 5A, 5B.

The invention is not limited in its application to the details of construction or the arrangement of the components set forth in the following description or illustrated in the drawings. The invention is capable of other embodiments or of being practiced or carried out in other various ways. Also, it is to be understood that the terminology and phraseology employed herein is for purpose of description and illustration and should not be regarded as limiting. Like reference numerals are used to indicate like components.

### DESCRIPTION OF THE ILLUSTRATED EMBODIMENTS

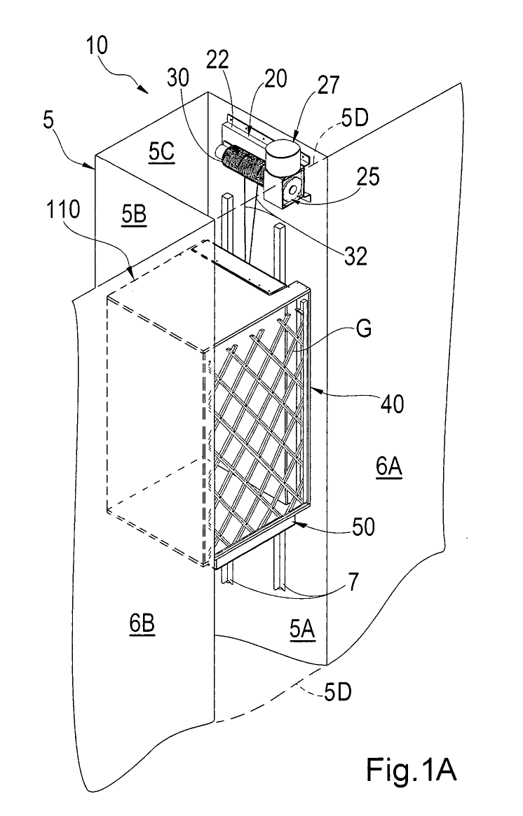

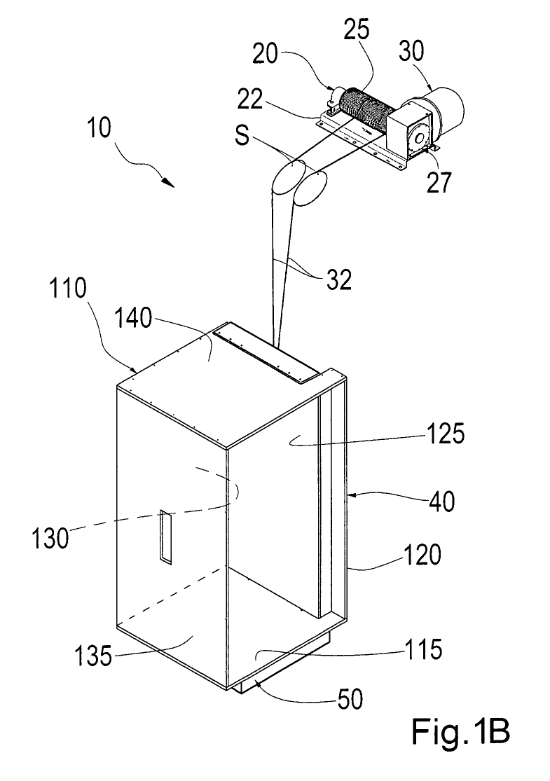

FIG. 1A illustrates elevator system 10 which includes a first embodiment of frameless-cab assemblies 40 of the invention. Elevator system 10 is installed in hoistway 5 of a building and is used to transport passengers and/or cargo up and/or down along the hoistway. Namely, elevator system 10 is adapted and configured to enable frameless-cab assemblies 40 of the invention to transport passengers and/or cargo in and along, for example, a generally vertically oriented travel path within hoistway 5.

Hoistway 5 generally defines a hollow elevator shaft in which elevator system 10 operates, such as a hollow elevator shaft in which frameless-cab assembly 40 travels. Hoistway 5 includes a plurality of walls, namely first and second hoistway side walls 5A, 5B, hoistway backwall 5C, and hoistway frontwall 5D, indicated in dashed outline in FIG. 1A. Each of the first and second hoistway side walls 5A, 5B, hoistway backwall 5C and hoistway frontwall 5D, has an inner surface which generally faces inwardly toward the center of hoistway 5.

The first and second hoistway side walls 5A, 5B are generally parallel to each other. Hoistway backwall 5C and frontwall 5D are generally parallel to each other, and extend between and generally connect to the first and second hoistway side walls 5A, 5B. Accordingly, the first and second hoistway side walls 5A, 5B, hoistway backwall 5C, and hoistway frontwall 5D, in combination, define a generally vertical columnar void which houses at least part of elevator system 10.

Hoistway 5 is part of, and/or attached to, a building such as, but not limited to, a residential building, a commercial building, and/or others. Walls of a building, such as walls 6A, 6B, can communicate with and/or be attached to e.g. hoistway side walls 5A, 5B and/or hoistway front wall 5D. Accordingly, hoistway 5 can be recessed generally behind a plane which extends across and between walls 6A, 6B, such as in the embodiment illustrated in FIG. 1A, namely behind front wall 5D.

Guiderails 7 are generally elongate members which are adapted and configured to enable frameless-cab assembly 40 to generally slidingly travel thereupon. Each of the guiderails 7 is mounted to the building structure, e.g. mounted to one of the walls 5A, 5B, or 5C, of hoistway 5, in a generally upright orientation, illustrated in FIG. 1A as a vertical orientation. Guiderails 7 have lengths which extend at least partially along the height of hoistway 5 enabling frameless-cab assembly 40 to travel a distance upwardly and/or downwardly which is compatible with the magnitude of the lengths of guiderails 7.

In general, elevator system 10 includes elevator drive assembly 20, cables 32 and optionally sheaves “S,” (FIG. 1B) the assemblage of which provides lifting/lowering forces for, and/or transmits lifting/lowering forces to, frameless-cab assembly 40. Accordingly, the assemblage of elevator drive assembly 20, cables 32, and optionally sheaves “S,” (FIG. 1B) enables a user of elevator system 10 to transport passengers and/or cargo in frameless cab assembly 40 upwardly and/or downwardly, as desired by such user.

Elevator drive assembly 20 has a base plate 22 upon which winding drum 30, gearbox 25, and a prime mover, e.g. electric motor 27 are each mounted, directly or indirectly. Winding drum 30 has one end of each of two cables 32 respectively attached thereto. The other end of each of cables 32 is attached to, optionally removably attached to, frameless-cab assembly 40.

Base plate 22, of elevator drive assembly 20, defines a mounting structure/bracket which has a medial portion disposed between two outer, lateral portions. The medial portion of base plate 22 provides a mounting surface upon which the remaining components of elevator drive assembly 20, namely gearbox 25, motor 27, and winding drum 30, are mounted, directly or indirectly. The two lateral portions of base plate 22 define elongate mounting tabs having a plurality of through bores extending therethrough. Each through bore is adapted and configured to receive mounting hardware therethrough which enables elevator drive assembly 20 to be mounted to e.g. a suitable mounting substrate.

Gearbox 25 includes a gearbox housing, a gear assembly, an input shaft, and an output shaft. Gearbox 25 is in driving communication with winding drum 30 and is attached to, e.g. generally fixedly secured to, base plate 22. The input and output shafts of gearbox 25 are respectively in driving communication with, and driven communication with, the gear assembly of gearbox 25. The gear assembly of gearbox 25 is adapted and configured to convert and/or transmit at least one of a direction of torque, a magnitude of torque, and a speed of rotation realized by the input shaft of gearbox 25 into a corresponding, but not necessarily equal, direction of torque, magnitude of torque, and/or speed of rotation realized by the output shaft of gearbox 25 which enables elevator drive assembly 20 to lift/lower frameless-cab assembly 40 at a desirable rate of speed/distance of travel.

Those skilled in the art are well aware of gear assemblies which are suitable to convert and/or transmit at least one of a direction of torque, a magnitude of torque, and a speed of rotation realized by the input shaft of gearbox 25 into a corresponding, but not necessarily equal, direction of torque, magnitude of torque, and/or speed of rotation realized by the output shaft of gearbox 25 which enables elevator drive assembly 20 to lift/lower frameless-cab assembly 40 at a desirable rate of speed/distance of travel. Such suitable gear assemblies include but are not limited to worm gear assemblies, spur gear assemblies, helical gear assemblies, crossed helical gear assemblies, bevel gear assemblies, spiral bevel gear assemblies, ring and pinion assemblies, planetary gear assemblies, and others.

Motor 27 is an AC or DC electric motor and optionally a single-phase AC or DC electric motor, which includes a motor output shaft in driving communication with the input shaft of gearbox 25 and optionally includes the input shaft of gearbox 25 in its entirety. Motor 27 realizes a working speed and working torque sufficiently great in magnitude to suitably rotate the input shaft of gearbox 25, the gears of gearbox 25, and the output shaft of motor 27 so as to lift and/or lower frameless-cab assembly 40 as desired, e.g. at a desired rate of travel, while still proving relatively economical to operate in terms of power consumption, maintenance, and other operating costs.

Winding drum 30 is adapted and configured to rotate about an axis of rotation which is generally perpendicular to the direction in which cables 32 extend outwardly from the drum 30. Winding drum 30 has first and second generally circular end walls, and an outer circumferential wall with surface characteristics, such as, but not limited to, one or more helical guide grooves which are formed into the outer surface of the outer circumferential wall. The helical guide grooves formed into the outer surface of the outer circumferential wall, extend helically circumferentially around the outer surface of the outer circumferential wall, and defines a concave groove perimeter having generally uniform groove radius, transverse to the direction of extension of the length of the respective grooves. The surface characteristics of the outer circumferential wall define a cooperating relationship with surface characteristics of e.g. cables 32 for capturing, winding up of the cables on the outer surface of the winding drum as the elevator is raised.

Conventional mounting hardware such as bolts, screws, and/or other suitable types of conventional mounting hardware, extend through each of the plurality of through bores which extend through each of the two lateral portions of base plate 22 and thereby attach base plate 22 to the suitable and/or desirable mounting substrate which can be a wall, a ceiling, a floor, or other suitable mounting substrates. In addition, conventional mounting hardware attaches piece-parts and/or subassemblies of elevator drive assembly 20, including but not limited to ones of winding drum 30, gearbox 25, and motor 27, to base plate 22 thereby mounting elevator drive assembly 20 in its entirety to such suitable substrate.

Cables 32 are generally flexible and elongate and have generally uniform diameters and radii, and first and second terminal ends. Cables 32 comprehend any of the variety of cable, wire, wire rope, and/or rope materials commonly known/used in the lifting/lowering industry, including but not limited to e.g. multi-strand wound steel cable, woven steel cable, and/or others.

The outer surfaces of cables 32 define arcs which generally correspond to the arcuate shapes of the concave helical guide grooves formed in the outer circumferential surfaces of winding drum 30 whereby cables 32 are adapted and configured to be windingly received by the helical guide grooves of winding drum 30. One of the first and second terminal ends of each cable 32 is attached to winding drum 30 and the other of the first and second terminal ends of each cable 32 is attached to frameless-cab assembly 40. Those skilled in the art are well aware of suitable hardware and means of using such hardware to attach and/or removably attach cables 32 to winding drum 30 and to frameless-cab assembly 40.

As will be described in greater detail hereinafter, frameless-cab assembly 40 includes sling 50 and cab 110. Cab 110 generally defines a “box-type” enclosure with at least one opening for passengers and/or cargo to enter and exit the cab.

Optionally, a gate and/or other enclosure device, e.g. gate “G,” or a door, retractably spans across the opening in cab 110. Those skilled in the art are well aware of suitable gates and/or other enclosure devices including but not limited to, scissors gates, accordion style gates, retractable doors, and others.

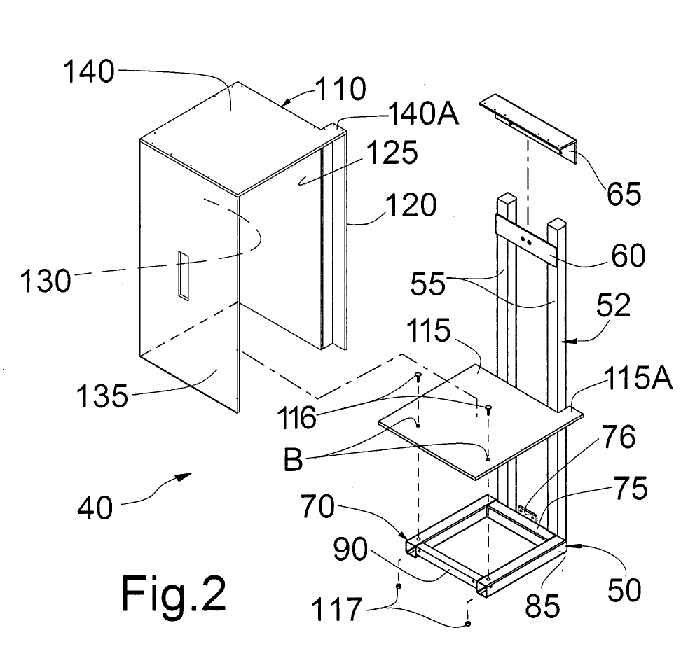

Cables 32 are attached to the generally “L-shape” assembly which includes sling 50 (FIG. 2). Cab 110 is also attached to sling 50, whereby a driving connection is realized between elevator drive assembly 20 and frameless-cab assembly 40.

As will be explained in greater detail hereinafter, frameless-cab assemblies 40 of the invention are relatively easy to assemble in relatively tight assembly quarters, such as the relatively tight assembly quarters defined by the hollow passage provided is by hoistway 5 and/or other relatively restrictive assembly environments.

Referring now to FIG. 1B, elevator system 10 can further include at least one sheave “S.” Each of sheaves “S” is generally circular and/or cylindrical. Each sheave “S” has first and second generally circular ends, and a circumferential outer surface, spanning between the ends, and which is adapted and configured to rotatably receive, for example, cables 32 thereupon. Sheave “S” acts as e.g. a pulley which may typically be adapted and configured to rotate about an axis of rotation along an arcuate distance of travel, which corresponds to that portion of the length of one of cables 32, which communicates with, and travels across, the outer circumferential surface of sheave “S.”

Accordingly, sheaves “S” provide a means to change the direction of force applied by elevator drive assembly 20 through cables 32, such as from a generally horizontal direction of force realized by cables 32 between winding drum 30 and sheaves “S” to a generally vertical direction of force realized by cables 32 between sheaves “S” and frameless-cab 40. In other words, sheaves “S” are positioned and/or installed so as to suitably enable a rotational movement of winding drum 30 to be converted to e.g. a generally vertically actuated linear movement of frameless-cab assembly 40. Those skilled in the art are well aware of suitable methods of mounting, suitable hardware for mounting with, suitable substrates to mount to, and suitable positional orientations in which to mount, sheaves “S” relative to elevator drive assembly 20 and frameless-cab assembly 40 to facilitate lifting/lowering frameless-cab assembly 40 in a desired manner.

Cab 110 includes the assemblage of a plurality of generally planar walls and optionally a gate and/or other enclosure device (FIG. 1A). Namely cab 110 includes (FIG. 1B) bottom wall 115, gate pocket 120, first sidewall 125, second sidewall 130, third sidewall 135, top wall 140, and optionally gate “G” (FIG. 1A).

The assemblage which includes cab 110 is attached to sling 50. Sling 50 is attached via cables 32 to elevator drive assembly 20, thereby to drivingly connect elevator drive assembly 20 to frameless-cab assembly 40.

Referring now to FIG. 2, sling 50 includes sling-upright assembly 52 and sling-base assembly 70. Sling-upright assembly 52 and sling-base assembly 70 in combination provides both vertical and lateral support structure for cab 110.

Sling-upright assembly 52 includes vertical posts 55, stabilizer plate 60, and sling stabilizer bracket 65. In the embodiments illustrated in the drawings, vertical posts 55 are generally elongate members, each having a length dimension, a top terminal end and a bottom terminal end. Vertical posts 55 have a generally upright, e.g. vertical, orientation, are laterally spaced from, and are generally parallel to, each other.

Stabilizer plate 60 defines a width dimension which corresponds generally to the magnitude of the distance by which vertical posts 55 are laterally spaced from each other. Stabilizer plate 60 spans generally perpendicularly between, and is attached to, each of vertical posts 55, adjacent the top terminal ends of vertical posts 55, thereby to connect ones of the vertical posts 55 to each other.

Sling stabilizer bracket 65 is optionally included in frameless-cab assembly 40 and is, for example, an “L-shaped” bracket which has a width dimension, a vertical portion and a horizontal portion. The width dimension of sling stabilizer bracket 65 also corresponds generally to the magnitude of the distance by which vertical posts 55 are laterally spaced from each other. The vertical portion of sling stabilizer bracket 65 is attached to vertical posts 55, adjacent the top terminal ends of vertical posts 55 and/or the stabilizer plate 60. The horizontal portion of sling stabilizer bracket 65 extends generally perpendicularly outwardly from vertical posts 55 so as to generally overlie at least a portion of sling-base assembly 70.

Sling-base assembly 70 includes back member 75, first side member 80, second side member 85, and front member 90. Back member 75 extends generally between and is attached to the bottom terminal ends of vertical posts 55, as well as being attached to, side members 80, 85. Front member 90 extends generally between, and is attached to, side members 80, 85.

Tab 76 is a generally planar tab which is attached to, and projects upwardly from, back member 75 generally between the vertical posts 55. In the embodiment illustrated in FIG. 2, the length of back member 75, defined between first and second terminal ends of back member 75, corresponds generally to the magnitude of the distance that separates vertical posts 55.

First and second side members 80, 85 extend generally perpendicularly outwardly from back member 75. Namely, first and second side members 80, 85 extend outwardly from, and are attached to, the first and second terminal ends of back member 75.

Front member 90 has first and second terminal ends which define a length therebetween. Front member 90 extends generally perpendicularly between, and is attached to, first and second side members 80, 85. In the embodiment illustrated in FIG. 2, the magnitude of the length dimension of front member 90 corresponds to the magnitude of the length dimension of back member 75 whereby sling-base assembly 70 defines a generally rectangular structure/platform which receives cab 110, and through which cab 110 is secured to sling 50. A plurality of through bores extends vertically through components of sling-base assembly 70. The through bores which extend through sling-base assembly 70 are adapted and configured to interface with corresponding mounting structure of cab 110. When components of sling-base assembly 70 are made from generally hollow materials, e.g. tubing and/or piping, the through bores can optionally extend through only the uppermost wall of such tubing and/or piping.

Cab 110 is attached to sling 50, at least partially, by the interfacing relationship of bottom wall 115 with sling-base assembly 70. Bottom wall 115 has upper and lower surfaces, a generally rectangular main body portion and a generally rectangular projection 115A which extends outwardly and coplanarly therefrom. Bottom wall 115 defines an outer perimeter which extends around the combination of the rectangular main body portion and the generally rectangular projection 115A.

A plurality of through bores extends through bottom wall 115 as mounting structure, e.g. mounting bores “B”. Ones of the through bores “B” preferably are in generally coaxial alignment with corresponding ones of the through bores which extend through sling-base assembly 70, which enables bottom wall 115 to be secured to sling 50 by e.g. conventional hardware. Namely, the combination of bolts 116 which extend through the through bores of bottom wall 115 and sling-base assembly 70, and nuts 117 which threadedly engage bolts 116 provide a mechanical connection between bottom wall 115 and sling-base assembly 70.

Cab 110 further includes a plurality of sidewalls which each has outer e.g. outwardly facing and inner e.g. inwardly facing surfaces. Accordingly, cab 110 generally defines outer and inner perimeter surfaces which correspond to the outer and inner surfaces of the plurality of sidewalls. The plurality of sidewalls extends generally vertically between bottom wall 115 and top wall 140. Namely, gate pocket 120, first sidewall 125, second sidewall 130, third sidewall 135 extend upwardly from bottom wall 115 and span between, and generally connect, bottom wall 115 and top wall 140. Thus, cab 110 generally defines an enclosure, or a cavity defined within an inner perimeter surface, in which passengers and/or cargo can be transported during use of elevator system 10.

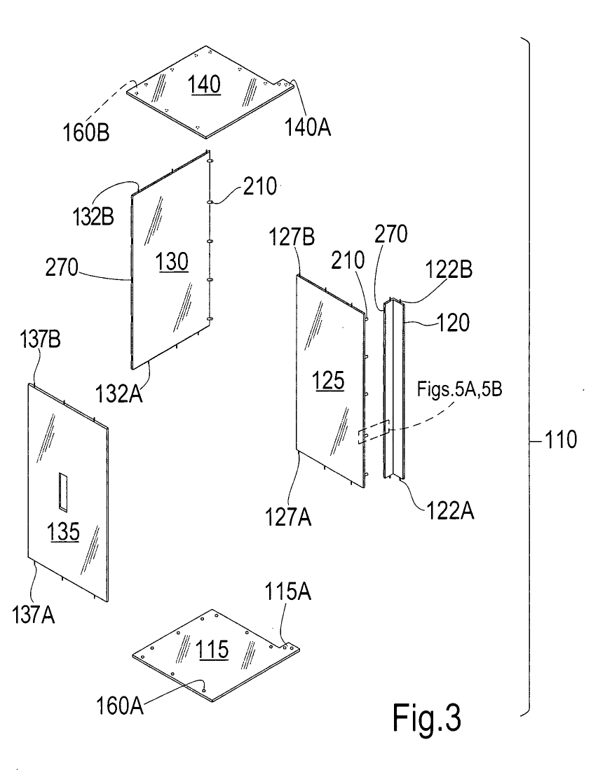

Referring now to FIG. 3, bottom wall 115 further includes a plurality of bores, namely perimeter bores 160A, which extend thereinto, alternatively therethrough. Perimeter bores 160 are located adjacent the outer perimeter of bottom wall 115, e.g. perimeter bores 160A are spaced relatively nearer the outer perimeter of bottom wall 115 than are mounting bores “B”.

Gate pocket 120 has a length, with corresponds to the height of cab 110, defined between upper and lower edges of the gate pocket, and gate pocket 120 includes first and second elongate portions which are generally rectangular, and are connected to each other, at e.g. a generally vertical seam. The first and second elongate portions generally define approximately a right angle therebetween, as viewed from directly above or below gate pocket 120. The approximate right angle between the first and second elongate portions defines a cavity in which gate “G” (FIG. 1A) is housed when not extended across the front of elevator cab 110.

Each of the first and second elongate portions has a lateral outer surface which can receive and mount fastener members, such as post fastener 210 and/or fastener bracket 270 and/or other mounting structure, which are attached thereupon and/or extend thereinto. The lower and upper edge surfaces of gate pocket 120 include dowels and/or other protrusions, namely protrusions 122A and 122B respectively, which extend outwardly therefrom. Protrusions 122A, 122B, post fastener 210, and fastener bracket 270 enable gate pocket 120 to interface with, and attach to, other components of cab 110.

First sidewall 125 is generally planar and rectangular and has first and second lateral edge surfaces, and upper and lower edge surfaces which define a length therebetween which corresponds to the height of cab 110. First sidewall 125 further includes an inwardly facing surface and an outwardly facing surface. A plurality of post fasteners 210 extend outwardly from the outwardly facing surface of first sidewall 125, adjacent one of the first and second lateral edge surfaces. The other one of the first and second lateral edge surfaces includes a plurality of fastener brackets 270 attached thereto. The lower and upper edge surfaces of first sidewall 125 include dowels and/or other protrusions, namely protrusions 127A and 127B respectively, which extend outwardly, e.g. upwardly or downwardly, therefrom.

Second sidewall 130 is generally planar and rectangular and has first and second lateral edge surfaces, and upper and lower edge surfaces which define a length therebetween which corresponds to the height of cab 110. Second sidewall 130 further includes an inwardly facing surface and an outwardly facing surface. A plurality of post fasteners 210 extend inwardly from the inwardly facing surface of second sidewall 130, adjacent one of the first and second lateral edge surfaces. The other one of the first and second lateral edge surfaces includes a plurality of fastener brackets 270 received therein and mounted thereto. The lower and upper edge surfaces of second sidewall 130 include dowels and/or other protrusions extending therefrom. Namely, protrusions 132A extend downwardly from the lower edge surface, and protrusions 132B extend upwardly from the upper edge surface, of second sidewall 130.

Third sidewall 135 is generally planar and rectangular and has first and second lateral edge surfaces, and upper and lower edge surfaces which define a length therebetween which corresponds to the height of cab 110. Third sidewall 135 further includes an inwardly facing surface and an outwardly facing surface. A plurality of post fasteners 210 (not shown) extend inwardly from the inwardly facing surface of third sidewall 135, adjacent one of the first and second lateral edge surfaces. The other one of the first and second lateral edge surfaces communicates with gate “G” when gate “G” is fully extended, e.g. closed (FIG. 1A). The lower and upper edge surfaces of third sidewall 135 include dowels and/or other protrusions extending therefrom. Namely, protrusions 137A extend downwardly from the lower edge surface, and protrusions 137B extend upwardly from the upper edge surface, of third sidewall 135.

Top wall 140 has upper and lower surfaces, a generally rectangular main body portion and a generally rectangular projection 140A which extends outwardly and coplanarly therefrom. Top wall 140 defines an outer perimeter which extends around the combination of the rectangular main body portion of the top wall, and the generally rectangular projection 140A. Top wall 140 further includes a plurality of bores adjacent the outer perimeter, namely perimeter bores 160B, which extend from the lower surface thereinto, alternatively therethrough.

Accordingly, cab sidewalls e.g. sidewalls 125, 130, 135, and/or other components of cab 110, define portions thereof which are suitable for attaching mounting hardware thereto, namely “edge regions,” although other portions of sidewalls 125, 130, 135, and/or other components of cab 110 can also provide suitable hardware mounting sites. Edge regions of sidewalls 125, 130, 135, and/or other components of cab 110 are defined at the respective sidewall lateral edge surfaces and further include, for example, (i) inwardly and outwardly facing surfaces adjacent the respective lateral edge surfaces, (ii) upper and lower edge surfaces adjacent the respective lateral edge surfaces, and (iii) other surfaces which are adjacent, and/or otherwise generally proximate to, the respective lateral edge surfaces.

In the assembled cab 110, ones of protrusions 122A of gate pocket 120 are frictionally received in corresponding ones of perimeter bores 160A which extend into rectangular projection 115A of bottom wall 115. Also, ones of protrusions 122B are frictionally received in corresponding ones of perimeter bores 160B which extend into rectangular projection 140A of top wall 140.

Protrusions 127A and 127B of first side panel 125 are frictionally received in corresponding ones of perimeter bores 160A and 160B of bottom wall 115 and top wall 140 respectively. Also, protrusions 132A and 132B of second side panel 130 are frictionally received in corresponding ones of perimeter bores 160A and 160B of bottom wall 115 and top wall 140 respectively, and protrusions 137A and 137B of third side panel 135 are frictionally received in corresponding ones of perimeter bores 160A and 160B of bottom wall 115 and top wall 140 respectively.

Thus, through the cooperation of protrusions 122A, 122B, 127A, 127B, 132A, 132B, 137A, 137B with perimeter bores 160A, 160B; gate pocket 120, and first, second and third sidewalls 125, 130, 135 are attached to bottom and top walls 115, 140, thereby to form the assembly which is labeled herein as cab 110.

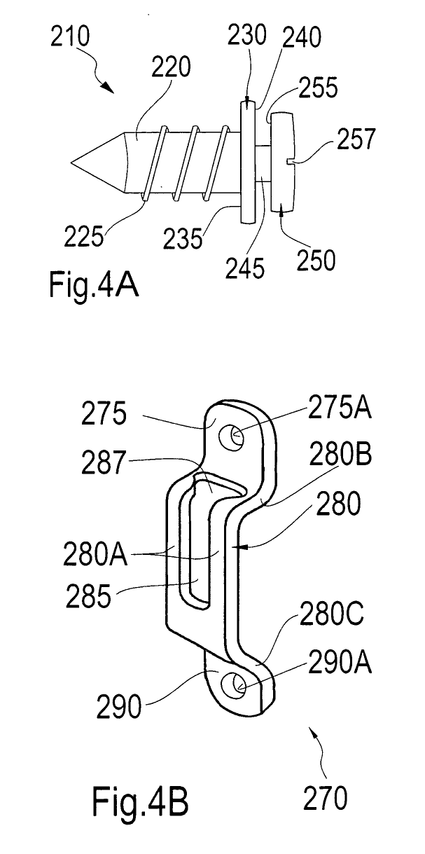

Referring now to FIG. 4A, post fastener 210 includes shank 220, shoulder 230, and head 250. Shank 220 is generally cylindrical, has first and second terminal ends, and an outer circumferential surface which defines a shank outer diameter. One of the first and second terminal ends defines a generally circular and planar surface and the other of the first and second terminal ends defines a point e.g. is generally conical or tapered. The outer circumferential surface of shank 220 includes helical threads 225 extending therefrom.

Shoulder 230 is an annular projection which includes two generally circular end surfaces. Namely, shoulder inner-surface 235 which faces a first direction toward the point and shoulder outer-surface 240 which faces a second, opposite, direction, toward head 250. Neck 245 is generally cylindrical, has first and second generally circular end surfaces, and an outer circumferential surface which defines a neck outer diameter. Head 250 is generally cylindrical, has first and second generally circular end surfaces, and an outer circumferential surface which defines a head outer diameter.

One of the first and second end surfaces of head 250 has interfacing structure, such as slot 257, which is adapted and configured to interface and/or cooperate with e.g. an installation tool. The other one of the first and second end surfaces of head 250 communicates with one of the first and second ends of neck 245. The first and second ends of neck 245 communicate with shoulder outer-surface 240. Shoulder inner-surface 235 communicates with the generally circular and planar end surface of shank 220.

In preferred embodiments, all the components of post fastener 210 are integral, and thus post fastener 210 is made from e.g. a single piece of “stock.” Those skilled in the art are well aware of materials suitable for use in post fasteners 210 and methods of making/manufacturing post fasteners 210.

Referring now to FIG. 4B, fastener bracket 270 includes first and second mounting lobes 275, 290 and receiving plate 280 positioned therebetween. Each of first and second mounting lobes 275, 290 is generally planar, have a top surface and a bottom surface, and each has an aperture which extends therethrough, e.g. aperture 275A, and aperture 290A, respectively.

Receiving plate 280 includes a generally planar body portion which has first and second lateral prongs 280A which extend generally upwardly and which define receiving channel 285 therebetween. Receiving channel 285 defines a slot opening between surfaces of the first and second lateral prongs 280A which face inwardly into channel 285. Receiving plate 280 further includes first and second elbow projections 280B, 280C. First elbow projection 280B is attached to, and extends away from, lateral prongs 280A and has channel opening 287 extending therethrough adjacent upper mounting lobe 275. Second elbow projection 280C is attached to, and extends away from, lateral prongs 280A adjacent mounting lobe 290, and is generally continuous across its entire width.

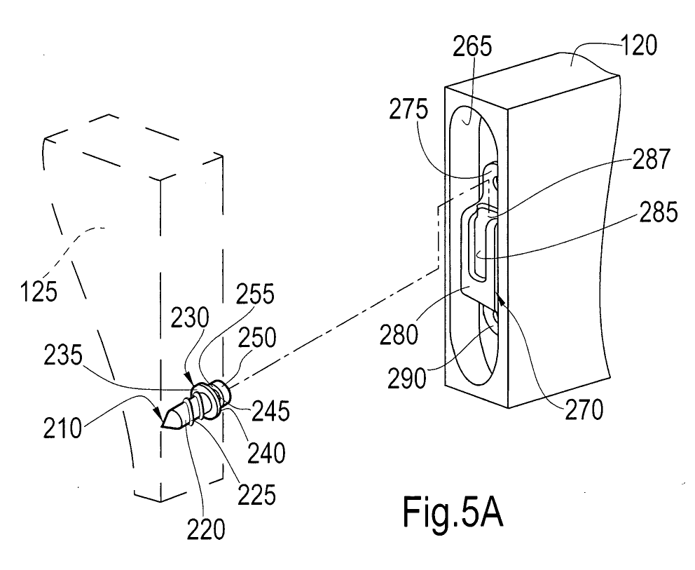

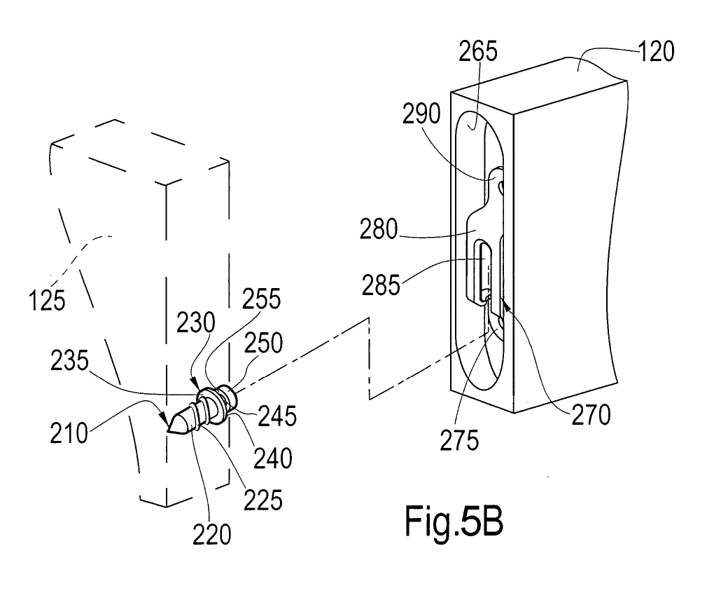

Referring to FIG. 5A, receiving plate 280 defines a plane which is not coplanar with a plane which extends across the first and second mounting lobes 275, 290 and which extends at a small, intersecting angle to such plane which extends across the first and second mounting lobes, such that the lateral distance between the lower end of plate 280 and mounting lobe 290 is smaller than the lateral distance between the upper end of plate 280 and mounting lobe 275. The ends of elbow projections 280B, 280C which are not connected to lateral prongs 280A are connected to lobes 275 and 290, respectively. Thus, receiving plate 280 defines an outwardly projected surface, relative to mounting lobes 275, 290 and slightly non-parallel with respect to mounting lobes 275, 290. Accordingly, a void is generally defined behind receiving plate 280.

Referring now to FIG. 5A, post fastener 210 and fastener bracket 270 are adapted and configured to cooperate with each other so as to enable a user to relatively easily assemble components of frameless cab assembly 40 to each other. Additionally, the cooperation of post fastener 210 and fastener bracket 270 generally provides dimensional stability, along at least two planes, between the respective communicating components of frameless cab assembly 40 which will be described in greater detail hereinafter.

Post fastener 210 is threadedly/grippingly attached to e.g. screwed into, the outer surface of first sidewall 125, adjacent one of the first and second lateral edge surfaces. Shank 220 is housed within first sidewall 125 so that the shoulder inner-surface 235, of shoulder 230, communicates with the outwardly facing surface of first sidewall 125. Accordingly, threads 225 of shank 220 provide a mechanical resistance to forces which tend to urge post fastener 210 outwardly from first sidewall 125, and shoulder 230, in combination with threads 225, provide mechanical resistance to forces which tend to urge post fastener 210 further inwardly, into first sidewall 125.

In preferred embodiments, fastener brackets 270 are attached to frameless cab assembly 40 so that receiving plate 280 sits generally flush with, alternatively slightly recessed behind, the outer surface of the structure in which the fastener brackets 270 are mounted. Namely, fastener bracket 270 can reside within a relief/pocket, such as mounting cavity 265, which is fabricated in an edge surface of the respective wall member as illustrated in FIG. 5A.

To realize the cooperating relationship between post fastener 210 and fastener bracket 270, a user (i) aligns post fastener 210 and fastener bracket 270, with the head of the post fastener adjacent and above slot 285 in bracket 270, and (ii) slidingly engages head 250 of post fastener 210 into the slot of fastener bracket 270.

Namely, a user initially aligns head 250 of post fastener 210 over channel opening 287, which faces/opens upwardly, of fastener bracket 270. Ordinarily, suitable initial alignment of post fastener 210 and fastener bracket 270 occurs approximately when post fastener 210 and fastener bracket 270 are collinear and when the two surfaces on the two components of frameless cab assembly 40, which are to interface with each other, are in, or are nearly in, face-to-face contact. Next, the user slides the component of frameless cab assembly 40 which has post fastener 210 installed therein generally downwardly relative to the component of frameless cab assembly 40 which has post fastener 210 installed therein, e.g. slides first sidewall 125 downwardly relative gate pocket 20 as illustrated in FIG. 5A. As sidewall 125 slides downward, the angled inner surface of lateral prongs 280A progressively more snugly-engages the inner surface 255 of head 250, thus bringing surface 255 into frictional engagement with the inner surface of prongs 280A.

Referring now to FIG. 5B, in some embodiments, opening 287 of fastener bracket 270 faces/opens downwardly. In such embodiments, the user aligns fastener bracket 270, illustrated as attached to gate pocket 120, over post fastener 210. Then, the user slides e.g. gate pocket 120 generally downwardly relative to e.g. first sidewall 125. It will be seen from the illustrations of FIGS. 5A, 5B, that the user moves the wall joinder hardware, being so manipulated, in a downward direction, relative to the other wall component, so as to take advantage of the force of gravity in the assembly operations. Such assembly movement can be accomplished in the opposite, upward-movement direction, but with the additional requirement of overcoming the force of gravity in so moving the such wall component.

Referring now to FIGS. 4A, 4B, 5A, and 5B, when post fastener 210 is slidingly and frictionally received and engaged in fastener bracket 270, a generally multi-dimensional stability is realized therebetween; along e.g. at least two planes.

In a cooperatingly engaged state between post fastener 210 and fastener bracket 270, head 250 of post fastener 210 is generally housed in the void which is generally defined behind receiving plate 280 of fastener bracket 270, and is slidingly and frictionally engaged with the inwardly facing surface of receiving plate 280. The outer diameter of neck 245 is lesser in magnitude than the magnitude of the slot opening diameter defined longitudinally across receiving channel 285. Neck 245 is housed within receiving channel 285 and the outer circumferential surface of neck 245 can intimately communicate with the surfaces of lateral prongs 280A which facing inwardly into receiving channel 285, in cooperation with the frictional engagement between surface 255 of the head and the inner surface of plate 280.

The interfacing and/or other intimate communication, e.g. abutment or friction, between neck 245 and lateral prongs 280A, through receiving channel 285, provides mechanical resistance to forces applied laterally to interfacing components of frameless cab assembly 40, e.g. gate pocket 120 and first sidewall 125. Accordingly, the cooperation between post fastener 210 and fastener bracket 270 provide, at least in part, general lateral stability to the assemblage of frameless cab assembly 40 along a first lateral direction.

Shoulder inner-surface 235 intimately communicates with the outwardly facing surface of sidewall 125, namely the surface of sidewall 125 which faces away from the void space defined inside cab assembly 40. Head inner-surface 255 of post fastener 210 intimately communicates with, and is frictionally engaged with, the inwardly facing surfaces of lateral prongs 280A, namely the surfaces of lateral prongs 280A which face toward, for example, gate pocket 120. As a result of the above-recited surface-to-surface interface, as first sidewall 125 is moved slidingly down, in engaging post-fastener 210 in bracket 270, the sliding of surface 255 of the head along the angled inner surfaces of lateral prongs 280A progressively draws side wall 125 closer and closer to gate pocket 120.

The interfacing and/or other intimate communication between parts of post fastener 210, namely shoulder 230 and head 250, with lateral prongs 280A and the other respective cab wall component, provides mechanical resistance to forces applied laterally to interfacing components of frameless cab assembly 40, e.g. gate pocket 120 and first sidewall 125. Accordingly, the cooperation between post fastener 210 and fastener bracket 270, including the sliding frictional engagement, provide substantial lateral stability to the assemblage of frameless cab assembly 40 along a second lateral direction which is generally perpendicular to the first lateral direction of lateral stability. Accordingly, the first lateral direction of stability refers to components of frameless cab assembly 40 resisting surface to surface sliding relative to each other. The second lateral direction of stability refers to components of frameless cab assembly 40 resisting being pulled apart from each other.

The interaction and cooperation of post fasteners 210 and fastener brackets 270 have thus far been discussed only in relation to two specific components of frameless cab assembly 40, namely, gate pocket 120 and first sidewall 125. However, the interactions and cooperations of post fasteners 210 and fastener brackets 270 apply equally as well to all interfacing components of frameless cab assembly 40 which utilize post fastener 210 and fastener bracket 270. Such interfacing includes, but is not limited to, the interfacing realized (i) between first sidewall 125 and second sidewall 130, (ii) between second sidewall 130 and third sidewall 135, (iii) in some embodiments, between bottom wall 115 and/or top wall 140 and ones of gate pocket 120 and sidewalls 125, 130, 135, and potentially (iv) between others.

Accordingly, in the assembled cab 110, adjacent pairs of, for example, gate pocket 120, and sidewalls 125, 130, 135, generally define vertical seams therebetween. Also, since post fasteners 210 and fastener brackets 270 are mounted to respective ones of gate pocket 120, and sidewalls 125, 130, 135 generally between outwardly and inwardly facing perimeter surfaces, namely outer and inner cab perimeter surfaces or an inner or outer surface adjacent a perimeter. Specifically, at each seam, one of the adjoining member has its connecting hardware mounted in its edge surface, and the other of the adjoining member has its connecting hardware mounted in either its inner or outer surface but adjacent the edge of the respective member. Thus, sidewall 125 has fastener 210 mounted at its outer surface, while sidewall 130 has fastener 210 mounted at its inner surface.

While all illustrated embodiments show fastener 210 mounted in inner and outer surfaces, with brackets 270 mounted in edge surface; the invention also contemplates the reverse, where fasteners 210 are mounted in the edge surfaces and brackets 270 are mounted at inner and/or outer surfaces. In addition, the invention contemplates a combination mount, where some of the fasteners 210 are mounted in edge surfaces, some at inner and/or outer surfaces; cooperatively some of the brackets 270 are mounted in edge surfaces, some at inner and/or outer surfaces. Further the mounting hardware along any given edge can include both fasteners and brackets, spaced from each other along the length of the edge.

For each fastener 210 in or adjacent an edge/perimeter of one wall component, a bracket 270 is mounted at a cooperating location along the respective edge/perimeter of the adjacent wall component. Similarly, for each bracket 270 in or adjacent and edge/perimeter of one wall component, a fastener 210 is mounted at a cooperating location along the respective edge/perimeter of the adjacent wall component. Thus, pairs of fasteners and brackets face, and interface with, each other at the respective joints which are defined between the respective wall components 120, 125, 130, 135, bottom wall 115, 140; and/or respective dowels 137A, 137B extend into respective bores 160A, 160B.

The outer and inner cab perimeter surfaces of cab 110 generally define substantially continuously planar surfaces, for example, between respective ones of the vertical seams. Thus, substantially no hardware which connects ones of the components of cab 110 to other ones of the components of cab 110 extend outwardly away from the outer cab perimeter surface, or extend inwardly away from the inner cab perimeter surface and into the inner cavity defined inside cab 110.

It should also be noted that different combinations of post fasteners 210 and fastener brackets 270, in relation to components of frameless-cab assembly 40, are fully within the scope of the current invention. As one non-limiting example, the lateral outer surface of gate pocket 120 can include post fastener 210 and the edge surface of first sidewall 125 can include fastener brackets 270. As another non-limiting example, fastener brackets 270 can be positioned and oriented in a variety of positions and orientations which are suitable for the intended use. Such positions and orientations include but not limited to, generally vertical orientation of fastener bracket 270 with channel opening 287 facing generally upwardly (FIG. 5A) or generally vertical orientation of fastener bracket 270 with channel opening 287 facing generally downwardly (FIG. 5B), and/or other suitable positions and orientations.

A number of economies attend the interaction and cooperation of components of frameless cab assembly 40. Namely, frameless cab assembly 40 enables an installer to realize a relatively simpler, and more economic, installation of frameless cab assembly 40, during installation of elevator system 10.

Referring now to FIG. 3, to assemble frameless cab 40, the user/installer first secures bottom wall 115 to sling 50 by aligning mounting bores “B” with the corresponding bores which extend through sling-base assembly 70. Next the user extends bolts 116 through the aligned bores and threadedly secures nuts 117 to bolts 116 and thereby secures bottom wall 115 to sling 50.

The user/installer then installs first sidewall 125. The user/installer aligns protrusions 127A with the corresponding perimeter bores 160A of bottom wall 115, and presses generally downwardly on first sidewall 125 which thereby inserts protrusions 127 into the corresponding perimeter bores 160.

Next, the user/installer installs the second sidewall 130. The user/installer generally aligns protrusions 132A over corresponding perimeter bores 160A of bottom wall 115. Preferably, the user/installer slightly tilts second sidewall 130 in a first direction so that only the protrusion 132A which is most distal first sidewall 125 is inserted, at least partially, into the corresponding perimeter bore 160.

The user/installer then rotates second sidewall 130 in a second, opposite, direction about a longitudinal axis perpendicular to the inner surface of sidewall 125, so as to insert the remaining ones of protrusions 132A into corresponding ones of perimeter bores 160. While so doing, the user/installer generally aligns post fasteners 210 of second sidewall 130 with corresponding fastener brackets 270 of first sidewall 125 (not illustrated). Substantially simultaneously with the insertion of the remaining ones of protrusions 132A into corresponding ones of perimeter bores 160, the user/installer slidingly engages the post fasteners 210 with corresponding ones of the fastener brackets 270 in the respective edge of sidewall 125. Accordingly, a multi-dimensional stability is realized between first and second sidewalls 125, 130.

Next, the user/installer installs the third sidewall 135. The user/installer generally aligns protrusions 137A over corresponding perimeter bores 160A of bottom wall 115. Preferably, the user/installer slightly tilts third sidewall 135 in a first direction so that only the protrusion 137A which is most distal second sidewall 130 is inserted, at least partially, into the corresponding perimeter bore 160.

The user/installer then rotates third sidewall 135 in a second, opposite, direction about a horizontal axis perpendicular to the inner surface of sidewall 135, so as to insert the remaining ones of protrusions 137A into corresponding ones of perimeter bores 160. While so doing, the user/installer generally aligns post fasteners 210 of third sidewall 135 (not illustrated) with corresponding fastener brackets 270 of second sidewall 130. Substantially simultaneously with the insertion of the remaining ones of protrusions 137A into corresponding ones of perimeter bores 160, the user/installer slidingly engages the post fasteners 210 with corresponding ones of the fastener brackets 270 in the respective edge of sidewall 130. Accordingly, a multi-dimensional stability is realized between second and third sidewalls 130, 135.

Next, the user/installer installs gate pocket 120. The user/installer generally aligns protrusions 122A over corresponding perimeter bores 160A of bottom wall 115, and pushes generally downwardly against gate pocket 120 and thereby inserts protrusions 122A into perimeter bores 160A. While so doing, the user/installer generally aligns ones of fastener brackets 270 of gate pocket 120 with corresponding ones of post fasteners 210, and engages the corresponding post fasteners 210 and fastener brackets 270.

The user/installer then installs top wall 140. The user/installer generally aligns perimeter bores 160B over corresponding protrusions 122B, 127B, 132B, 137B. The user/installer urges top wall 140 generally downwardly by, for example, gripping and pulling downwardly on top wall 140 through an aperture (not illustrated) which extends therethrough and which is adapted and configured to house e.g. a light (not illustrated). The downward force applied against top wall 140 by the user/installer inserts protrusions 122B, 127B, 132B, 137B into corresponding perimeter bores 160B.

It should be noted that frameless-cab assembly 40, when assembled as described above, need not have any hardware that protrudes outwardly into hoistway 5 nor any hardware which protrudes inside cab 110. The outer surfaces of gate pocket 120, and sidewalls 125, 130, 135 generally define a continuous, uninterrupted perimeter which includes a plurality of substantially planar surfaces wherein each such wall surface is substantially void of outwardly protruding hardware, and intersects with other ones of the substantially planar surfaces at approximately right angles. Thus, the assembled frameless-cab assembly 40 generally realizes an outer perimeter which is generally polygonal and which has sides defined substantially by the generally planar outer surfaces of gate pocket 120, and sidewalls 125, 130, 135, wherein the generally polygonal outer perimeter is generally and/or substantially devoid of any hardware protruding outwardly of the generally planar outer surfaces which define the outer perimeter.

As frameless-cab assembly 40 is substantially devoid of hardware protruding into hoistway 5, a user/installer can assemble frameless-cab assembly 40 without having to stand or otherwise position him/herself “outside” of the projected area defined by the assembled frameless-cab assembly 40, which positioning outside the projected area of the cab is typically required during the installation/assembly of elevator cabs of the prior art and which have outwardly-protruding hardware.

Accordingly, the steps of assembling frameless-cab assembly 40 can be performed by a user/installer at a location in intimate proximity to sling 50 and correspondingly can be performed in a relatively space-restricted area. Namely, a user-installer can assemble frameless-cab assembly 40 from generally within a vertical projection of the space which is defined by the fully assembled frameless-cab assembly 40. In particular, gate pocket 120, sidewalls 125, 130, 135, top wall 140, and other components of e.g. frameless-cab assembly 140, can be assembled to each other while the user/installer stands on, or is otherwise in close proximity to, bottom wall 15. Accordingly, a user/installer can assemble frameless-cab assembly within, for example, the relatively space-restricted area of the generally hollow elevator shaft of hoistway 5.

Preferably, components of elevator system 10 are made of materials which resist corrosion or other degradation in the expected use environment, and are suitably strong and durable for normal extended use. Those skilled in the art are well aware of certain metallic and non-metallic materials which possess such desirable qualities for use in force transmission devices, and appropriate methods of forming such materials.

Appropriate metallic materials for components of, or parts of components of, elevator system 10 such as part of elevator drive assembly 20 namely plate 22, winding drum 30, gearbox 25, motor 27, and others, as well as at least parts of sheave “S,” post fastener 210 and fastener bracket 270, can be selected from but are not limited to, aluminum, steel, stainless steel, titanium, magnesium, brass, and their respective alloys. Common industry methods of forming such metallic materials include casting, forging, shearing, bending, machining, grinding, riveting, welding, powdered metal processing, extruding and others.

Non-metallic materials suitable for components of elevator system 10 such as parts of elevator drive assembly 20, e.g. any various seals/o-rings, parts of any bearing assemblies, and others, can be selected from various polymeric compounds, such as for example and without limitation, various of the polyolefins, such as a variety of the polyethylenes, e.g. high density polyethylene, or polypropylenes. There can also be mentioned as examples such polymers as polyvinyl chloride and chlorinated polyvinyl chloride copolymers, various of the polyamides such as nylon, polycarbonates, and others.

For any polymeric materials employed in structures of the invention, any conventional additive package can be included such as, for example and without limitation, slip agents, anti-block agents, release agents, anti-oxidants, fillers, and plasticizers, to assist in controlling e.g. processing of the polymeric material as well as to stabilize and/or otherwise control the properties of the finished processed product, also to control hardness, bending resistance, and the like.

Common industry methods of forming such polymeric compounds will suffice to form such non-metallic components of elevator system 10. Exemplary, but not limiting, of such processes are the various commonly-known plastics converting processes.

Other non-metallic substances and materials suitable for use in components of elevator system 10, namely bottom wall 115, gate pocket 120, sidewalls 125, 130, 135, top wall 140, and others, include certain rigid, fibrous, materials such as wood and engineered wood products.

Common industry methods of forming or otherwise constructing such wood and engineered wood products will suffice to form such non-metallic components of elevator system 10. Exemplary forming methods include, but are not limited to, cutting, planning, sanding, staining, finishing, adhering, laminating, veneering, and others.

Individual components of elevator system 10 can be assembled as subassemblies to be later joined and/or attached to other subassemblies and/or other components of elevator system 10. Such subassemblies include, but are not limited to, guiderails 7, elevator drive assembly 20, sling 50, and others.

Those skilled in the art will now see that certain modifications can be made to the apparatus and methods herein disclosed with respect to the illustrated embodiments, without departing from the spirit of the instant invention. And while the invention has been described above with respect to the illustrated embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

While the present invention is illustrated with reference to force transmission devices having particular configurations and particular features, the present invention is not limited to these configurations or to these features and other configurations and features can be used.

Having thus described the invention, what is claimed is:

1. A frameless elevator cab, comprising:
(a) a plurality of sidewalls each having an upper portion and a lower portion and each having an outwardly facing surface and an inwardly facing surface, relative to a load-bearing cavity inside said frameless elevator cab, said outwardly facing surfaces collectively defining an outer cab perimeter and said inwardly facing surfaces collectively defining an inner cab perimeter;
(b) a top wall communicating with the upper portions of said plurality of sidewalls; and
(c) a bottom wall communicating with the lower portions of said plurality of sidewalls;
said outwardly facing surfaces of said sidewalls collectively defining at least a substantial portion of the cab outer perimeter and said inwardly facing surfaces of said sidewalls collectively defining at least a substantial portion of the cab inner perimeter, said elevator cab outer perimeter, at said sidewalls, being substantially devoid of hardware extending therefrom and connecting ones of the sidewalls to each other and extending outwardly therefrom.

2. A frameless elevator cab as in claim 1, said sidewalls comprising edge regions, at least some of said sidewalls comprising edge surfaces at the edge regions, said frameless elevator cab further comprising a first fastener member mounted on a first one of said sidewalls, in the edge region of said first sidewall at one of the inner surface, the outer surface, or the edge surface, and connecting one of said first sidewalls to a second one of said sidewalls through a second fastener member mounted in the edge region of said second sidewall, said second fastener member being mounted at one of the inner surface, the outer surface, or the edge surface of said second sidewalls, said first and second fastener members being substantially disposed between the inwardly facing surfaces and the outwardly facing surfaces of said first and second sidewalls.

3. A frameless elevator cab as in claim 1, said first fastener member comprising a shoulder and a head, and a neck which extends between said shoulder and said head, said second fastener member comprising a receiving plate adapted and configured to receive said neck of said first fastener member.

4. A frameless elevator cab as in claim 3 wherein said first and second fastener members cooperate so as to generally provide dimensional stability along at least first and second directions of stability to said frameless cab at an assembled cab corner defined by said first and second sidewalls, the first direction of stability being generally parallel to the direction of projection of said first fastener member and said second direction of stability being generally perpendicular to the direction of projection of said first fastener member.

5. A frameless elevator cab as in claim 1 further comprising an elevator cab closure, said closure, in combination with said sidewalls, when closed, defining the inner perimeter of said frameless cab.

6. A frameless elevator cab, comprising:
(a) a top wall and a bottom wall;
(b) a plurality of sidewalls each having an outer sidewall surface, an upper sidewall surface, and opposing upstanding edge regions, each of said sidewalls extending generally between said top wall and said bottom wall; said sidewalls collectively defining a plurality of corners of said frameless cab at respective ones of said edge regions, and a cargo cavity inside said frameless elevator cab; and
(c) connecting hardware in said edge regions connecting said sidewalls to each other at the corners;
said connecting hardware being substantially confined to facing portions of the respective edge regions of the sidewalls so joined, such that said connecting hardware is substantially non-visible as viewed from inside the cargo cavity.

7. A frameless elevator cab as in claim 6, at least some of said sidewalls comprising edge surfaces at the edge regions, a first one of said fastener member being mounted on a first one of said sidewalls, in one said edge region, at one of the inner surface, the outer surface, or the edge surface, and connecting said first sidewall to a second said sidewall through a second fastener member mounted in an edge region of said second sidewall, said second fastener member being mounted at one of the inner surface, the outer surface, or the edge surface, said first and second fastener members being substantially disposed between the inwardly facing surfaces and the outwardly facing surfaces of said first and second sidewalls.

8. A frameless elevator cab as in claim 6, said connecting hardware comprising first and second fastener members, said first fastener member comprising a shoulder and a head, and a neck which extends between said shoulder and said head, said second fastener member comprising a receiving plate adapted and configured to receive said neck of said first fastener member.

9. A frameless elevator cab as in claim 8 wherein said first and second fastener members cooperate so as to generally provide dimensional stability to said frameless cab at a such cab corner defined by said first and second sidewalls along at least first and second directions, the first direction of stability being generally parallel to said direction of projection of said first fastener and said second direction of stability being generally perpendicular to the direction of projection of said first fastener member.

10. A frameless elevator cab as in claim 6 further comprising an elevator cab closure, said closure, in combination with said sidewalls, when closed, defining the inner perimeter of said frameless cab.

11. A frameless elevator cab, comprising:
(a) a top wall and a bottom wall;
(b) a plurality of sidewalls each having an inner sidewall surface, an outer sidewall surface, and opposing upstanding edge regions, and each of said sidewalls extending generally between said top wall and said bottom wall, said sidewalls collectively defining a plurality of corners of said frameless cab at respective ones of said edge regions, and a cargo cavity inside said frameless cab; and
(c) connecting hardware in said edge regions connecting said sidewalls to each other at the corners, said connecting hardware being substantially confined to facing portions of the respective edge regions of the sidewalls so joined, such that said connecting hardware is substantially non-visible as viewed from outside said frameless cab.

12. A frameless elevator cab as in claim 11, at least some of said sidewalls comprising edge surfaces at the edge regions, a first one of said fastener member being mounted on a first one of said sidewalls, in one said edge region, at one of the inner surface, the outer surface, or the edge surface, and connecting said first sidewall to a second said sidewall through a second fastener member mounted in an edge region of said second sidewall, said second fastener member being mounted at one of the inner surface, the outer surface, or the edge surface, said first and second fastener members being substantially disposed between the inwardly facing surfaces and the outwardly facing surfaces of said first and second sidewalls.

13. A frameless elevator cab as in claim 11, said connecting hardware comprising first and second fastener members, said first fastener member comprising a shoulder and a head, and a neck which extends between said shoulder and said head, said second fastener member comprising a receiving plate adapted and configured to receive said neck of said first fastener member.

14. A frameless elevator cab as in claim 13 wherein said first and second fastener members cooperate so as to generally provide dimensional stability to said frameless cab at a such cab corner defined by said first and second sidewalls along at least first and second directions, the first direction of stability being generally parallel to said direction of projection of said first fastener and said second direction of stability being generally perpendicular to the direction of projection of said first fastener member.

15. A frameless elevator cab as in claim 11 further comprising an elevator cab closure, said closure, in combination with said sidewalls, when closed, defining the inner perimeter of said frameless cab.

16. A frameless elevator cab comprising:
(a) a top wall and a bottom wall;
(b) a plurality of sidewalls extending generally between said top wall and said bottom wall and joined to each other so as to generally define said frameless cab, and a cargo cavity inside said frameless cab, each of said sidewalls having inner and outer sidewall surfaces and upstanding edge regions, including edge regions having edge surfaces which extend generally between the respective inner and outer surfaces; and
(c) at least one fastener member extending outwardly from and/or inwardly into a respective one of the edge surfaces, and fastening first and second ones of said walls to each other;
wherein the inner and outer sidewall surfaces of such assembled frameless cab generally define substantial portions of inner and outer cab perimeters, such inner and outer cab perimeters, at respective joinders of said sidewalls, being substantially devoid of hardware attaching ones of the top wall, bottom wall, and sidewalls to each other and extending inwardly from said sidewalls into the cargo cavity.

17. A frameless elevator cab as in claim 16, said sidewalls comprising edge regions, at least some of said sidewalls comprising edge surfaces at the edge regions, said frameless elevator cab further comprising a first fastener member mounted on a first one of said sidewalls, in the edge region of said first sidewall at one of the inner surface, the outer surface, or the edge surface, and connecting one of said first sidewalls to a second one of said sidewalls through a second fastener member mounted in the edge region of said second sidewall, said second fastener member being mounted at one of the inner surface, the outer surface, or the edge surface of said second sidewalls, said first and second fastener members being substantially disposed between the inwardly facing surfaces and the outwardly facing surfaces of said first and second sidewalls.

18. A frameless elevator cab as in claim 16, said first fastener member comprising a shoulder and a head, and a neck which extends between said shoulder and said head, said second fastener member comprising a receiving plate adapted and configured to receive said neck of said first fastener member.

19. A frameless elevator cab as in claim 18 wherein said first and second fastener members cooperate so as to generally provide dimensional stability along at least first and second directions of stability to said frameless cab at an assembled cab corner defined by said first and second sidewalls, the first direction of stability being generally parallel to the direction of projection of said first fastener member and said second direction of stability being generally perpendicular to the direction of projection of said first fastener member.

20. A frameless elevator cab as in claim 16 further comprising an elevator cab closure, said closure, in combination with said sidewalls, when closed, defining the inner perimeter of said frameless cab.

21. A frameless cab elevator system kit, comprising:
(a) a prime mover;
(b) a pair of generally elongate guiderails;
(c) a sling in driven communication with said prime mover and movable along said pair of generally elongate guiderails; and
(d) a frameless cab attached to said sling, said frameless cab comprising
(i) a top wall and a bottom wall, and
(ii) a plurality of sidewalls each having an outer sidewall surface and each extending generally between said top wall and said bottom wall; and
said outer sidewall surfaces defining a substantial portion of a cab outer perimeter, such cab outer perimeter, adjacent said sidewalls, being devoid of hardware, connecting ones of the sidewalls to each other and extending substantially outwardly from said sidewalls.

22. A method of assembling a frameless elevator cab which has top and bottom walls, and first, second, and third sidewalls, the method comprising:
(a) connecting the first sidewall to a bottom wall so that the bottom wall is generally parallel to the ground and the first sidewall extends generally upwardly from the bottom wall;
(b) aligning a second sidewall, which has a lower corner portion distal from the first sidewall and a lateral edge portion proximate the first sidewall, with the first sidewall, and interfacing the lower corner portion of the second sidewall with the bottom wall and subsequently interfacing the lateral edge portion of the second sidewall with the first sidewall and slidingly engaging the first and second sidewalls so as to realize a multi-dimensionally stable connection therebetween;
(c) aligning a third sidewall which has a lower corner portion distal from the second sidewall and a lateral edge portion proximate the second sidewall, with the second sidewall, and interfacing said lower corner portion of the third sidewall with the bottom wall and subsequently interfacing the lateral edge portion of the third sidewall with the second sidewall and slidingly engaging the second and third sidewalls so as to realize a multi-dimensionally stable connection between the second and third sidewalls.

23. A method of assembling a frameless elevator cab as in claim 22 wherein the frameless elevator cab further comprises a gate pocket, the method further comprising:
(d) generally perpendicularly aligning a gate pocket which has a lower corner portion distal from the first sidewall and a lateral edge portion proximate the first sidewall, with the first sidewall, and interfacing the lower corner portion of the gate pocket with the bottom wall and subsequently interfacing the lateral edge portion of the gate pocket with the first sidewall and slidingly engaging the first sidewall and the gate pocket so as to realize a multi-dimensionally stable connection therebetween.

24. A method of assembling a frameless elevator cab as in claim 23, further comprising:
(e) generally aligning the top wall with the first, second, and third sidewalls and the gate pocket so that the top wall generally superposes the bottom wall and applying pressure against the top wall in the direction of the bottom wall thereby interfacing the top wall with the first, second, and third sidewalls and the gate pocket.

25. A frameless elevator cab assembly comprising:
(a) a sling having a generally upright sling portion and a generally horizontal sling portion which is generally perpendicular to said generally upright portion; and
(b) a frameless cab attached to at least one of said generally upright sling portion and said generally horizontal sling portion, said frameless cab comprising
(i) a top wall and a bottom wall, and
(ii) a plurality of sidewalls each having an outer sidewall surface and each extending generally between said top wall and said bottom wall; and
said outer sidewall surfaces defining a substantial portion of a cab outer perimeter, such cab outer perimeter, adjacent said sidewalls, being devoid of hardware, connecting ones of the sidewalls to each other and extending substantially outwardly from said sidewalls.
